(19) United States
(12) Patent Application Publication
(10) Pub. No.: US 2024/0381897 A1
(43) Pub. Date: Nov. 21, 2024

(54) AQUATIC ANIMAL FEED COMPOSITIONS AND USES THEREOF

(71) Applicant: UNIVERSITEIT ANTWERPEN, Antwerpen (BE)

(72) Inventors: Siegfried VLAEMINCK, Destelbergen (BE); Gudrun DE BOECK, Keerbergen (BE); Abbas ALLOUL, Antwerpen (BE)

(73) Assignee: UNIVERSITEIT ANTWERPEN, Antwerpen (BE)

(21) Appl. No.: 18/722,303

(22) PCT Filed: Dec. 22, 2022
(86) PCT No.: PCT/EP2022/087604

§ 371 Date: Jun. 20, 2024

(30) Foreign Application Priority Data
Dec. 23, 2021 (EP) 21217439.5

(51) Int. Cl. A23K 10/18; A23K 50/80

(52) U.S. Cl. CPC A23K 10/18; A23K 50/80

(57) ABSTRACT

The invention provides methods of increasing the reproductivity, growth rate and/or pigmentation of an aquatic animal, such as fish by feeding said aquatic animal with a feed composition comprising purple bacteria. The invention further provides feed compositions for use in such methods.

### FIELD OF THE INVENTION

The presented invention is situated in the field of environmentally sustainable feed compositions to improve reproductivity, growth and color of aquatic animals.

### BACKGROUND OF THE INVENTION

In aquaculture and ornamental fish systems, nutrition plays a vital role to assure the welfare of aquatic animals. The market and associated environmental aspects continue to grow spurring feed suppliers to use novel and ecological ingredients to boost health, fitness and color such as microbial biomass, originating from yeasts, microalgae or bacteria (Spiller et al., 2020).

Purple bacteria have shown potential as an animal feed ingredient due to the fact that their biomass is high in protein, essential vitamins (e.g. vitamin B2, B6, B12, C, E, D and folic acid) and carotenoid pigments (e.g. spirilloxanthin, rhodopsin, okenone and rhodopinal).

In Alloul et al. (2021), it was reported that dietary inclusion of purple non-sulfur bacteria (PNSB) in feed compositions resulted in improved growth performance of shrimp (Litopenaeus vannamei) compared to a commercial diet. In this study, two PNSB species, Rhodopseudomonas palustris and Rhodobacter capsulatus, were used as an added-value protein ingredient in two different concentrations (5 and 10 g PNSB biomass per 100 g feed; PNSB 85% dry weight).

Microbial biomass is expensive however and its use at such concentrations is not economically viable in most cases. Typically, production costs for microbial biomass, even produced on waste streams, side streams or byproducts are higher than the market price of fishmeal or soybean meal.

In CN107156426 A, it was disclosed that compositions comprising Spirulina, Bacillus Subtilis, beer yeast powder, prodigiosin and traces of Rhodopseudomonas palustris (concentration between 0.1 and 1.0 g per 100 g feed), enhance the pigmentation, improve the body weight and the survivability of Salmon fish. Previous feeding tests conducted solely with Bacillus species also showed positive effects on growth performance and antipathogenic properties (Vibio harveyi, Aeromonas hydrophilia and Streptococcus agalactiae) for several aquatic animals such as salmon, Persian sturgeon, Nile tilapia (Faramarzi et al. 2012).

A similar observation was reported in CN109897803: a combination of Bacillus subtilis, Saccharomyces cerevisiae, Lactobacillus plantarum, a specific Rhodopseudomonas palustris strain (HEW-GJ106; concentration between 10⁵ and 10⁷ CFU per g feed) enhanced the growth performance, weight gain and survival rate of several aquatic animals.

The previous disclosures relate to the use combinations of different microorganisms with or without purple bacteria, often added directly to the tank. This are not viable for feed producers because production of microbes is enormously expensive. For commercial purposes, there remains a need to identify a purple bacteria-based composition that can improve reproductivity in aquatic animals and, at low concentrations, ensure other health benefits, such as microbial resistance in various aquatic species.

### SUMMARY OF THE INVENTION

The invention relates to the finding that purple bacteria and more particularly purple non-sulfur bacteria have general beneficial effects for a large range of aquatic animals, that they have unexpected specific beneficial properties such as for ornamental fish and can moreover also be used in concentrations in feed that are economically relevant e.g. also in aquaculture. More particularly, the results demonstrate that Rhodopseudomonas and Rhodobacter species are of particular interest for these applications. Interestingly, it has been found that these PNSB can replace other components used in feed, such as other bacteria.

In a first aspect, the invention relates to the use of purple bacteria to stimulate reproductivity in aquatic animals. The inventors have demonstrated that the use of purple bacteria in feed significantly increases reproduction of aquatic animals. Accordingly, in a first aspect, the invention provides methods of increasing the reproductivity of an aquatic animal by feeding said aquatic animal with a feed composition comprising purple bacteria to the aquatic animal population. The aquatic animals envisaged in these methods include but are not limited to fish and crustaceans. In particular embodiments, the bacteria are purple non-sulfur bacteria. In further embodiments, the bacteria are Rhodopseudomonas or Rhodobacter species. In most particular embodiments, the bacteria are from the species Rhodopseudomonas palustris and/or Rhodobacter capsulatus.

The inventors have moreover observed a significant effect of these purple bacteria on the growth and/or weight gain of fish. Accordingly, a further related aspect of this invention provides methods of increasing the growth rate or weight gain of fish by feeding said fish with a feed composition comprising purple bacteria in a concentration of 10 g per 100 g feed or less. The fish envisaged in these methods include but are not limited to ornamental fish and fish used as food or feed source.

Additionally, the inventors observed that the effect observed for these purple bacteria on reproductivity and growth or weight gain of fish, or other aquatic animals can be obtained using relatively low concentrations, more particularly low concentrations in feed, opening up their potential for use in aquaculture. Thus, in particular embodiments, the aforementioned methods are applied to increase the reproductivity, growth rate/weight gain of aquatic animals such as fish or crustaceans by feeding said fish or crustaceans with a composition comprising purple bacteria in a concentration of 5 g per 100 g feed or less, such as 4.5 g per 100 g feed or less. In particular embodiments, these methods are used in the aquaculture of fish and crustaceans. In particular embodiments of these methods, the bacteria are purple non-sulfur bacteria (PNSB). In further embodiments, the bacteria are Rhodopseudomonas or Rhodobacter species. In most particular embodiments, the bacteria are from the species Rhodopseudomonas palustis and/or Rhodobacter capsulatus.

Finally, a further surprising finding of the inventors was the effect of purple bacteria in feed on the pigmentation of fish. This is of particular interest for the cultivation of ornamental fish but can also be of interest in the cultivation of certain fish (such as salmon) or crustacean where color enhancement can be of commercial value. Accordingly, a further related aspect of this invention provides methods of increasing the pigmentation of an aquatic animal by feeding said aquatic animal with a composition comprising purple bacteria in a concentration of 10 g per 100 g feed or less, such as between 5 and 10 g per 100 g feed or less, such as between 1 and 5 g per 100 feed. In particular embodiments, these methods are used in the cultivation of ornamental fish. In further embodiments, the ornamental fish is a Poecilia species such as Poecilia reticulata. In particular embodiments of these methods, the bacteria are purple non-sulfur bacteria. In further embodiments, the bacteria are Rhodopseudomonas or Rhodobacter species. In most particular embodiments, the bacteria are from the species Rhodopseudomonas palustis and/or Rhodobacter.capsulatus.

The inventors have moreover observed a significant effect of these purple bacteria with respect to disease control in aquatic animals. Accordingly, a further related aspect of this invention provides methods of disease prevention and treatment in aquatic animals by feeding said aquatic animals with a feed composition comprising purple bacteria, preferably in a concentration of 10 g per 100 g feed or less, such as 2 g per 100 g feed or less.

The aquatic animals envisaged in these methods include but are not limited to fish and crustaceans. In particular embodiments, the bacteria are purple non-sulfur bacteria. In further embodiments, the bacteria are Rhodobacter species. In most particular embodiments, the bacteria are from the species Rhodobacter capsulatus.

A further related aspect of this invention are aquatic feed compositions or formulations defined for use in the methods of the invention. Accordingly, the invention provides an aquatic animal feed composition or formulation comprising purple bacteria. In particular embodiments, the feed is a fish feed and the purple bacteria are present in a concentration of 10 g per 100 g feed or less, such as between 1 and 10 g per 100 g feed, such as about 5 g per 100 g feed or about 2 g per 100 g feed. In particular embodiments of the fish feed composition or formulation, the bacteria are purple non-sulfur bacteria (PNSB). In further embodiments, the bacteria are Rhodopseudomonas or Rhodobacter species. In most particular embodiments, the bacteria are from the species Rhodopseudomonas palustris or Rhodobacter capsulatus. The invention also envisages feed formulations comprising the purple bacteria of the invention specifically formulated for use in aquaculture. In further embodiments, the invention envisages feed formulations for crustacea. In particular embodiments, the feed is fish feed for ornamental fish and the purple bacteria are present in a concentration between 5 and 10 g per 100 g feed. In more particular embodiments, the ornamental fish is a Poecilia species such as Poecilia reticulata. In alternative particular embodiments, the purple bacteria are present in a concentration of about 5 g per 100 g feed or less, such as 4.5 g per 100 g feed or less, such as 2 g per 100 g feed or less and said feed is for use in aquaculture of aquatic animals. In more particular embodiments, the aforementioned feed composition is a crustacean feed composition wherein the purple bacteria are present in a concentration of 4.5 g per 100 g feed or less.

### DETAILED DESCRIPTION OF THE INVENTION

Before the present system and method of the invention are described, it is noted that this invention is not limited to particular systems and methods or combinations described, since such systems and methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any 23, 24, 25, 26 or 27 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

It is to be understood that other embodiments may be utilised and structural or logical changes may be made without departing from the scope of the present invention. The following detailed description, therefore, is not to be taken in a limiting sense, and the scope of the present invention is defined by the appended claims.

The present invention thus relates to ingredients of aquatic animal feed compositions as described herein and their use. Aquatic animal feed compositions are used for feeding aquatic animals that are bred or kept in water tanks, reservoirs, basins, lakes, aquaria, and other housing, also referred to herein as water tanks.

The term “aquatic animal” as used herein refers to animals that live predominantly in different natural aquatic habitats, such as seas, oceans, rivers, lakes, ponds, reservoirs etc. but also in aquaria and other housing. These aquatic habitats may be freshwater, marine or brackish water. Aquatic animals possess morphological and anatomical adaptations that enable them to live and thrive in aquatic habitats.

The term “fish” as used herein refers to aquatic, craniate, gill-bearing animals that lack limbs with digits. The fish species belong to the class of Actinopterygii.

The term “ornamental fish” as used herein refers to fish species, kept in home, i.e. small scale aquariums or for aesthetic purposes. Ornamental fish encompass a wide variety of species and are characterized by a wide variety of sizes, shapes and colors.

The term “crustacean” as used herein refers to animals belonging to the Crustacea subphylum, including animals such as crabs, lobsters, crayfish, shrimp, krill, prawns, woodlice, barnacles, copepods, amphipods and mantis shrimp.

The term aquaculture as used herein refers to the farming of aquatic organisms such as fish, molluscs, crustaceans, aquatic plants, crocodiles, alligators, turtles and amphibians.

The aspect of farming implies some form of intervention in the rearing process to enhance production such as regular stocking, feeding, protection from predators. Farming also implies individual or corporate ownership of the stock being cultivated.

The term “aquatic feed composition” or aquatic feed formulations as used herein refers to compositions for fomulations generally comprising proteins, lipids, amino acids, fatty acids, minerals, vitamins, prebiotics, probiotics, pigments, antioxidants, fibres. Typically, the feed compositions comprise between 45-65% fishmeal. An exemplary aquatic feed composition may contain fishmeal, wheat, wheat pollard, monocalciumphosphate, limestone calcium, carboxymethylcellulose, L-lysine HCL, Tuna oil and one or more of D-Ca-Patothenate, Methionine, Necotinic Acid, Oxytetracycline Hydrochloride and Vitamin K.

The term “reproductivity” as used herein refers specifically to the number of offspring generated during a single breeding event. In this perspective, the term “reproductivity” should not be interpreted as the total number of offspring generated during the lifetime of an aquatic animal. In this way, this term should be considered independently from the aspect survivability.

The present invention is aimed at providing additional or alternative ingredients for said feed formulations. In particular embodiments, purple bacteria of the invention are used as an additional ingredient for said aquatic feed formulations. In further embodiments, the use of the purple bacteria of the invention is aimed at replacing probiotics (or other bacterial species than purple bacteria), such as Pediococcus acidilactici. In particular embodiments, the feed compositions of the invention do not comprise probiotics and/or other bacteria than the purple bacteria of the invention. In particular embodiments, the feed compositions substantially do not comprise or do not comprise one or more of Bacillus subtilis, Saccharomyces cerevisiae, Lactobacillus plantarum. In particular embodiments, the total amount of bacteria present in the feed composition comprise less than 20%, more particularly less than 10%, even preferably less than 5% bacteria other than PNSB, more particularly the PNSB described herein. In particular embodiments, the total amount of bacteria in the feed compositions of the invention comprise less than 20%, more particularly less than 10%, even preferably less than 5% Bacillus subtilis, Saccharomyces cerevisiae, Lactobacillus plantarum.

In further embodiments, the use of the purple bacteria of the invention is aimed at replacing microalgal biomass used in aquatic feed compositions. Accordingly, in particular embodiments, the aquatic feed compositions do not comprise microalgal biomass. In particular embodiments the use of the purple bacteria of the invention is aimed at replacing compounds such as astaxanthin presently used in aquatic feed compositions. Accordingly, in particular embodiments, the aquatic feed compositions of the invention do not contain astaxanthin. In further embodiments, the aquatic feed compositions of the invention comprise purple bacteria but do not comprise one or more of or do not comprise any of (bacterial) probiotics, microalgal biomass and astaxanthin.

Different species, life stage and rearing purposes of aquatic animals may require a different type of feed. For instance, there will be a difference in the composition or formulation of fish feed used for fish in aquaculture, fish feed used for ornamental fish and feed used for the cultivation of crustaceans. In addition, the protein concentration in fish feed is generally determined by the type of the fish (herbivore, carnivore, omnivore). In addition the ingredients or supplements used may be different.

Feed for aquatic animals can be made in different ways. For instance, feed for aquatic animals can be prepared by mixing the different ingredients followed by subsequent grinding and extrusion processes. Commercial aquatic animal feed products are typically available as dry feed pellets as this is the most convenient product for storage and distribution, but other forms of feed are also possible, such as but not limited to flakes and granules. The size of pellets can be different according to the type of aquaculture method and aquatic organism.

According to the invention, the different types of aquatic animal feeds envisaged herein are characterized by the presence of purple bacteria (PB), such as purple sulfur bacteria (PSB) or purple non-sulfur bacteria (PNSB); In particular the embodiments the bacteria used in the present invention are photosynthetic purple bacteria. In further particular embodiments, the bacteria are from the species Rhodopseudomonas or Rhodobacter. The experiments have been carried out using the species Rhodopseudomonas palustris (Rps. pal.) and Rhodobacter capsulatus (Rb. cap.). However, the skilled person will understand that while these species yielded optimal results, similar results may be obtained using comparable bacteria. In preferred embodiments of the invention, the species of purple non-sulfur bacteria is Rhodobacter capsulatus (Rb. cap.).

The concentration of the purple bacteria in the feed as used herein is expressed in total weight % of the feed (g bacteria per 100 g feed) measured as dry weight. Typically, the purple bacteria will comprise 10% (i.e. 10 g per 100 g feed) or less, particularly less than 10%, such as between 0.5-9.5%, 5% or less, such as between 0.5 and 5%, such as below 4.5%, or about 1, 2, 3 or 4% of the feed by weight. The bacteria are typically added to the feed during the mixing process with the other ingredients.

The concentration of the purple bacteria in feed can also be expressed in colony-forming units (cfu). CFU measures viable cells and is typically represented in CFU/ml. In the case of gram-negative bacteria, to which the purple bacteria belong, it is considered that 1 g/mL of dried biomass corresponds to 1×10¹¹ CFU/mL.

The detailed current invention encompasses different methods to improve the welfare of aquatic animals. As a secondary advantage, in particular embodiments, a more sustainable aquaculture production is obtained.

The methods of the invention involve feeding aquatic animals with the feed as described herein. The feeding of the aquatic animal with the feed compositions as described herein implies that the feed compositions of the invention ensure the desired caloric intake of the aquatic animal. Depending on the size and type of the aquatic animal this implies contacting the aquatic animal with the feed composition once every 6, 12, 18, 24, 36, 38 hours or more. For ornamental fish this is typically once every 24-48 hours. For fish in aquaculture, this is typically once every 6, 12, 18, 24, 36, 38 hours or more.

The amount of feed administered to the aquatic animal will also be dependent on the nature of the aquatic animal and the size of the unit of the feed composition. In particular embodiments, slow release formulations are provided in which release of the feed composition over time is ensured.

Typically the amount of feed to be added to the water will be determined per aquatic animal and life stage or per average amount of animal biomass per volume of water in the tank where the aquatic animal is kept. Typically the amount of feed provided will be between 5-10% of the bodymass for larvae and between 1-2% bodyweight for adults.

The aquatic animals are typically fed with the compositions of the inventions by adding the feed to the water present in the tank in which the aquatic animal is being bred or kept. The feed composition can be actively submerged in the water or distributed on the surface of the water. In particular embodiments, customized containers are used to introduce the feed into the water.

The invention relates to the finding that purple bacteria have beneficial effects to a large range of aquatic animals, that they have unexpected beneficial properties and can moreover be used in concentrations that are economically relevant also in aquaculture. More particularly, the results demonstrate that species of Rhodopseudomonas or Rhodobacter are of particular interest for these applications.

In a first aspect, the invention relates to the use of purple bacteria as described herein to stimulate reproductivity in aquatic animals. The inventors have demonstrated that the use of purple bacteria in feed significantly increases reproduction of aquatic animals as indicated in the examples section. Accordingly, in a first aspect, the invention provides methods of increasing the reproductivity of an aquatic animal by feeding said aquatic animal with a feed composition comprising the purple bacteria. The means by which the species are added to the aquatic animals are not critical but preferably the species are added to a feed composition and the aquatic animals are fed with said feed composition. The addition of the PNSB to the feed renders the use of PNSB feasible for aquaculture and aquariculture.

The aquatic animals envisaged in these methods include but are not limited to fish and crustaceans. In particular embodiments, the fish are ornamental fish. In further particular embodiments, the ornamental fish is a Poecilia species such as Poecilia reticulata. In particular embodiments of these methods, the bacteria are purple non-sulfur bacteria. In further embodiments, the bacteria are Rhodopseudomonas or Rhodobacter species. In most particular embodiments, the bacteria are from the species Rhodopseudomonas palustris or Rhodobacter capsulatus. In particular embodiments, these PNSB avoid the use of other bacteria and/or other components in the feed as detailed above.

The inventors have moreover observed a significant effect of the purple bacteria on the growth or body weight of fish. Accordingly, a further related aspect of this invention provides methods of increasing the growth rate or body weight of fish by feeding said fish with a feed composition comprising purple bacteria in a concentration of 10 g per 100 g feed or less, such as between 1 g and 10 g per 100 g feed, or between 1 and 9 g per 100 g feed, or between 5 and 10 g per 100 g feed. In particular embodiments, these PNSB avoid the use of other bacteria and/or other components in the feed as detailed above. This effect is indicated in the examples section. The means by which the species are added to the fish are not critical but preferably the species are added firstly to the feed composition and the fish are fed with said feed composition. In particular embodiments of these methods, the bacteria are purple non-sulfur bacteria. In further embodiments, the bacteria are Rhodopseudomonas and/or Rhodobacter species. In most particular embodiments, the bacteria are from the species Rhodopseudomonas palustris or Rhodobacter capsulatus.

The fish envisaged in these methods include but are not limited to ornamental fish and fish used as food or feed source. In particular embodiments, the fish are ornamental fish. In further particular embodiments, the ornamental fish is a Poecilia species such as Poecilia reticulata.

Additionally, the inventors observed that the effect observed for purple bacteria on growth of fish, or other aquatic animals can be obtained using relatively low concentrations, particularly when used in feed compositions, opening up their potential for use in aquaculture. Thus, in particular embodiments, the aforementioned methods are applied to increase the growth rate or weight gain of fish or crustaceans by feeding said fish or crustaceans with a composition comprising purple bacteria in a concentration of 4.5 g per 100 g feed or less, such as between 1 and 4.5 g per 100 g feed. The means by which the species are added to the fish or crustaceans are not critical but preferably the species are added firstly to the feed composition and the fish or crustaceans are fed with said feed composition. In particular embodiments of these methods, the bacteria are purple non-sulfur bacteria present in a concentration of 4.5 g per 100 g feed or less, such as between 1 and 4.5 g per 100 g feed. This is particularly of interest as the use of PNSB reduces the need for other components, more particularly other bacteria in the feed as detailed above. In further embodiments, the bacteria are Rhodopseudomonas and/or Rhodobacter species. In most particular embodiments, the bacteria are from the species Rhodopseudomonas palustis or Rhodobacter capsulatus. In particular embodiments, these methods are used in the aquaculture of fish and crustaceans. In particular embodiments, the fish are ornamental fish. In further particular embodiments, the ornamental fish is a Poecilia species such as Poecilia reticulata.

Finally, a further surprising finding of the inventors was the effect of purple bacteria in feed on the pigmentation of fish. This is of particular interest for the cultivation of ornamental fish or in other aquatic animals where color is of commercial interest (such as salmon or crustacea). However, the effect on the color of ornamental fish observed by the inventors is particularly surprising. Indeed, it has previously been reported that PNSB (in combination with other bacteria) can stimulate the preferred color in salmon. The color formation mechanism in salmon is however different than for ornamental fish. In ornamental fish, color always develops in pigment cells in the skin. For example, goldfish tend to see brown in the first year due to the dominant presence of melanocytes that color dark (as camouflage).

The color can be influenced by external factors such as light, temperature and food (astaxanthin). In salmon the color in the muscle is based entirely on the presence of carotenoids in the food (especially astaxanthin). In larval salmon this is even an essential part of the diet. It is fat soluble so is stored in the fat droplets in the cells. Accordingly, the color formation in salmon is more easily controlled and is not representative for other types of aquatic animals.

Accordingly, a further related aspect of this invention provides methods of increasing the pigmentation of an aquatic animal, particularly aquatic animals other than salmon, by feeding said aquatic animal with a composition comprising purple bacteria in a concentration of 10 g per 100 g feed or less to the aquatic animal population. This effect is supported by the examples section which demonstrates a clear increase in color intensity measured by international standards and by objective color analysis. In particular embodiments of these methods, the bacteria are purple non-sulfur bacteria. In further embodiments, the bacteria are Rhodopseudomonas and/or Rhodobacter species. In most particular embodiments, the bacteria are from the species Rhodopseudomonas palustis or Rhodobacter capsulatus.

The means by which the species are added to the fish are not critical but preferably the species are added to the feed composition and the fish are fed with said feed composition.

In particular embodiments, these methods are used in the cultivation of Poecilia species such as Poecilia reticulata.

The inventors have further found that the aquatic animal feed compositions of the invention comprising purple bacteria exhibit antipathogenic. The purple bacteria of the invention can thus be used to reduce mortality and improve the immune system in aquatic animals. This is also of particular interest in cultivated fish. In particular embodiments, the fish are ornamental fish. In further particular embodiments, the ornamental fish is a Poecilia species such as Poecilia reticulata. The invention thus provides the compositions of the invention for use in the treatment and/or prevention of pathogenic infections in aquatic animals. In particular embodiments, the pathogens are microbial pathogens, such as pathogenic bacteria. Accordingly, the application also provides methods for improving resistance to pathogens and/or reducing mortality in aquatic animals comprising feeding said aquatic animals with a feed composition comprising the purple bacteria in a mass concentration of 20 g per 100 g feed or less, preferably at a concentration of 10 g per 100 g feed or less, most preferably at a concentration of 5 g per 100 g feed, most preferably at a concentration of less than 5 g per 100 g, such as between 1 and 5 g per 100 g feed, such as about 2 g per 100 g feed. This effect is supported by the examples section which demonstrates a clear increase in survival of fish exposed to pathogens. In particular embodiments of these methods, the bacteria are purple non-sulfur bacteria. In further embodiments, the bacteria are Rhodobacter species. In most particular embodiments, the bacteria are from the species Rhodobacter capsulatus. In particular embodiments, the PNSB avoid the need for other components, such as other bacteria in the feed bacteria in the feed. Preferably, the bacteria present in the feed essentially only comprise PNSB.

As detailed above, the amount used may also be determined by economic factors such that the concentrations envisaged for use in ornamental fish may be higher. In particular embodiments of these methods, the bacteria are purple non-sulfur bacteria. In further embodiments, the bacteria are Rhodopseudomonas and/or Rhodobacter species. In most particular embodiments, the bacteria are from the species Rhodopseudomonas palustris or Rhodobacter capsulatus.

A further related aspect of this invention are aquatic feed compositions such as feed compositions or formulations defined for use in the methods of the invention. Accordingly, the invention provides an aquatic animal feed composition comprising purple bacteria. In particular embodiments of these feed compositions, the purple bacteria are purple non-sulfur bacteria. In further embodiments, the bacteria are Rhodopseudomonas and/or Rhodobacter species. In most particular embodiments, the bacteria are from the species Rhodopseudomonas palustris or Rhodobacter capsulatus

In particular embodiments, the feed is a fish feed and the purple bacteria are present in a concentration of 10 g per 100 g feed or less, such as between 1 and 9 g per 100 g feed, such as for instance about 2 g per 100 g feed or about 5 g per 100 g feed or between 5 and 10 g per 100 g feed. In particular embodiments, the amount of PNSB is below 10 g per 100 g feed. In particular embodiments, the amount of PNSB is below 5 g per 100 g feed. In particular embodiments, the bacteria are from the species Rhodopseudomonas palustis and/or Rhodobacter capsulatus. In particular embodiments, said fish are ornamental fish and the fish feed is suitably adapted therefor. In more particular embodiments, said ornamental fish is a Poecilia species, such as Poecilia reticulata.

In particular embodiments of the aquatic feed compositions of the invention, the aquatic feed composition is a fish feed and the purple bacteria are present in a concentration of 4.5 g per 100 g feed or less, such as between 1 and 4.5 g per 100 g feed. In particular embodiments, the fish feed is a fish feed adapted for fish in aquaculture.

In particular embodiments, the aquatic animal feed composition is a crustacean feed composition comprising the purple bacteria in a concentration of 4.5 g per 100 g feed or less, such as between 1 and 4.5 g per 100 g feed.

### EXAMPLES

A first feeding trial was set up with the species Rhodopseudomonas palustis or Rhodobacter capsulatus involving Poecilia reticulata. as a model system for aquatic animals. The feeding trial included three different diets, according to the compositions indicated in Table 1. The feeds were prepared according to the preparation method described in Alloul et al. (2021).

TABLE 1
Composition of the applied diets for the feeding trial 1. The
amounts in the table are expressed as g ingredient per 100
g feed. The compositions for the different diets are formulated
in such a way that all diets are isonitrogeneous (40% crude
protein), isolipidic (10%) and isoenergetic (4,400 Kcal).

| Diets | Control | PNSB |
|---|---|---|
| PNSB-species | 0.0 | 5.0 |
| Fishmeal | 59.4 | 55.5 |
| Wheat | 20.2 | 20.0 |
| Wheat pollards | 14.0 | 14.0 |
| Monocalciumphosphate | 2.4 | 1.6 |
| Limestone Calcium | 0.4 | 0.0 |
| Carboxymethylcellulose | 1.0 | 1.0 |
| L-Lysine HCl | 0.0 | 0.2 |
| Premix Aqua Bio Fulda | 1.5 | 1.5 |
| 1.5% | | |
| Tuna oil | 1.1 | 1.3 |

The different diets were tested in a feeding trial with Poecilia reticulata with 10 individual fish per tank in a volume of 8 liter. This experiment was executed in triplicate. The fish population were fed at 5% of their body weight for 16 weeks. The body weight was measured weekly and the amount of feed was adapted accordingly. After this period, three growth parameters were determined: specific growth rate (d), the feeding ratio (g feed g-fish) and weight gain. In addition to these growth parameters, the pigmentation of the fish (color) was assessed by visual examination and scored by an expert judge according to international standards.

For the breeding experiments, two parents from the same diet were used. The breeding parameter was assessed by counting the individual offspring per breeding event.

The results of the different experiments related to feeding trial 1 are shown in Table 2.

TABLE 2
Feeding trial 1, involving Poecilia reticulata, with a
commercial feed (control) and two purple non-sulfur bacteria
species (Rhodopseudomonas palustris and Rhodobacter capsulatus)
in a concentration of 5 g PNSB per 100 g feed. Three repetitions
per feed experiments were executed and the indicated values
are the averages ± standard deviations.

| Diets | Control | Rps. pal. | Rb. cap. |
|---|---|---|---|
| SGR (% day −1) | 1.3 ± 0.2 | 1.4 ± 0.0 | 1.6 ± 0.1 |
| Initial weight (g) | 0.65 ± 0.2 | 0.64 ± 0.1 | 0.65 ± 0.2 |
| Final weight (g) | 4.06 ± 0.4 | 4.80 ± 0.3 | 6.12 ± 0.4 |
| Weight gain (g) | 3.41 ± 0.5 | 4.16 * ± 0.2 | 5.47 * ± 0.4 |
| FCR (g feed/g fish | 4.5 ± 0.9 | 3.9 ± 0.3 | 3.1 ± 0.3 |
| biomass) | | | |
| Off spring (—) | 5 ± 1 | 25 * ± 2 | 26 * ± 1 |
| Color | 16 ± 3 | 17 ± 1 | 17 ± 4 |

* Indicate significant difference to the control at P = 0.05.

Preliminary experiments of the inventors indicate that the concentration of the purple bacteria can be reduced to less than 5% while maintaining a significant effect.

Similar experiments are performed determining the effect of the compositions on the resistance of pathogens of aquatic animals and mortality.

A second feeding trial was set up with purple non-sulfur bacteria species Rhodobacter capsulatus in two different concentrations. Poecilia reticulata (guppy) was used as a model system for aquatic animals. The feeding trial included three different diets formulated according to the compositions indicated in Table 3. The feeds were prepared according to the preparation method described in Alloul et al. (2021).

TABLE 3
Composition of the applied diets for feeding trial 2. The amounts
in the table are expressed as g ingredient per 100 g feed.
The compositions for the different diets are formulated in
such a way that all diets are isonitrogenous (45% crude protein),
isolipidic (10%) and isoenergetic (4,515 Kcal).

| Diets | Control | Rb Capsulatus | Rb Capsulatus |
|---|---|---|---|
| PNSB-species | 0.0 | 2.0 | 10.0 |
| Fishmeal | 57.3 | 56.2 | 52.3 |
| Wheat | 22.2 | 22.6 | 16.2 |
| Wheat pollards | 14.6 | 13.8 | 12.6 |
| Monocalciumphosphate | 0.4 | 0.0 | 0.0 |
| Limestone Calcium | 0.46 | 0.04 | 0.0 |
| Carboxymethylcellulose | 1.0 | 1.0 | 1.0 |
| L-Lysine HCl | 0.2 | 0.23 | 0.3 |
| Premix Aqua Bio Fulda | 1.5 | 1.5 | 1.5 |
| 1.5% | | | |
| Tuna oil | 2.3 | 2.4 | 4.6 |

Prior to the experiment, all fish (0.068 t 0.01 grams) were mixed and randomly distributed into 8-litres tanks with 10 individual fish per tank. The experiment was executed in triplicate. The fish were fed 5% their body (wet) mass for 10 weeks. During this period, their body weight was measured after every two weeks, and the amount of feed was adapted accordingly. After the feeding trial, three growth parameters were determined: specific growth rate (d⁻¹), the feed conversion ratio (g feed g⁻¹ fish) and weight gain. In addition to these growth parameters, the pigmentation of the fish (color) was assessed by visual examination and scored by an expert judge according to international standards (Inspection). Color components RGB (Red, Green & Blue) were also analyzed with adobe photoshop and then transformed to HSL (Hue, Saturation & Lightness) values (Color Analysis).

A breeding experiment was carried out after the feeding trial. Pregnant females from each feeding replicate were identified, and each female was kept separately in tanks.

Identification of pregnant females was done by observing the dark gravid spot and bulging of the belly. A net was used to separate the mother from the fries to prevent predation of the young by their mothers. After approximately 5 days of separation, they produced offspring, that were counted individually to assess the breeding parameter.

To investigate the effect of Rb. capsulatus on the immunity and disease resistance of the guppy, a challenge test was executed. For this experiment, 9 males from each diet (treatment) were randomly selected and each male was placed in a 1 L container containing 500 ml of water. A single culture of Aeromonas hydrophila cultured in TSB medium at 28° C. to mid-logarithmic growth was used to challenge the fish. 25 ml of the bacteria media with a concentration of 2.9×10⁹ colony-forming units/mL (CFU/ml) was added to each container.

Survival was then observed every 2 hours for a period of 48 hours post-infection.

TABLE 4
Feeding trial, involving Poecilia reticulata, with a commercial
feed (control) and purple non-sulfur bacteria species (Rhodobacter
capsulatus) with inclusion levels of 2 g PNSB per 100 g feed
and 10 g PNSB per 100 g feed. Three replications per feed
experiments were executed and the indicated values are
the averages ± standard deviations.

| Diets | Control | Rb. cap. (2%) | Rb. cap. (10%) |
|---|---|---|---|
| SGR (% day −1) | 1.7 ± 0.1 | 1.8 ± 0.2 | 1.6 ± 0.4 |
| Initial weight (g) | 0.65 ± 0.0 | 0.72 ± 0.1 | 0.706 ± 0.2 |
| Final weight (g) | 2.8 ± 0.1 | 3.62 ± 0.1 | 2.726 ± 0.3 |
| Weight gain (g) | 2.15 ± 0.1 | 2.90 ± 0.0* | 2.02 ± 0.1 |
| FCR (g feed/g fish | 2.1 ± 0.2 | 1.7 ± 0.2 | 2.2 ± 0.4 |
| biomass) | | | |
| Off spring (—) | 13 ± 2 | 16 ± 3 | 22 ± 2* |
| Inspection | 14.2 ± 3.0 | 16 ± 1.7 | 16.3 ± 3.0 |
| Color Analysis | 82.67 ± 1.2 | 87.42 ± 1.4* | 86.33 ± 1.7* |
| Survival Rate (%) | 33.3 | 77.8* | 66.7* |

*Indicate significant difference to the control at P = 0.05.

### REFERENCES

Alloul et al. (2021). Purple bacteria as added-value protein ingredient in shrimp feed: Penaeus vannamei growth performance, and tolerance against Vibrio and ammonia stress. Aquaculture 530: 735788.

Spiller et al. (2020). Environmental impact of microbial protein from potato wastewater as feed ingredient Comparative consequential life cycle assessment of three production systems and soybean meal. Water Research 171:115406.

Faramarzi et al. (2012). Influences of probiotic bacilli via bioencapsulated Daphnia magna on resistance of Persian sturgeon larvae against challenge tests. Global Veterinaria 8(4): 421-425.

1-16. (canceled)

17. An aquatic animal feed composition, comprising purple non-sulfur bacteria in a mass concentration below 10 g per 100 g feed.

18. The aquatic animal feed composition according to claim 17, wherein said aquatic animal is a fish.

19. The aquatic animal feed composition according to claim 18, wherein said fish is an ornamental fish.

20. The aquatic animal feed composition according to claim 19, wherein the ornamental fish is a Poecilia reticulata.

21. The aquatic animal feed composition according to claim 17, which is aquaculture feed composition.

22. The aquatic animal feed composition of claim 17, wherein the aquatic animal is a crustacean and the feed composition comprises said purple non-sulfur bacteria in a mass concentration below 4.5 g per 100 g feed.

23. The aquatic animal feed compositions of claim 17, wherein said purple non-sulfur bacteria are Rhodopseudomonas and/or Rhodobacter species.

24. The aquatic animal feed composition of claim 23, wherein said species are Rhodopseudomonas palustris and/or Rhodobacter capsulatus.

25. The aquatic animal feed composition of claim 17, wherein said feed composition does not comprise other bacteria.

26. A method of increasing the reproductivity or growth rate or increasing the pigmentation of an aquatic animal by feeding said aquatic animal with a feed composition comprising purple non-sulfur bacteria according to claim 17, thereby increasing the reproductivity, growth rate or increasing the pigmentation of said aquatic animal.

27. The method of claim 26, wherein said purple non-sulfur bacteria are Rhodopseudomonas and/or Rhodobacter species.

28. The method of claim 27, wherein said species are Rhodopseudomonas palustris and/or Rhodobacter capsulatus.

29. The aquatic animal feed composition of claim 23, wherein said species are Rhodopseudomonas palustris and/or Rhodobacter capsulatus.
